(19) United States
(12) Patent Application Publication
(10) Pub. No.: US 2008/0185044 A1
(43) Pub. Date: Aug. 7, 2008

(54) SYSTEM AND METHOD OF CHEMICAL DILUTION AND DISPENSE

(75) Inventors: Michael Clarke, Bedford, MA (US); Marc Laverdiere, Wakefield, MA (US); Robert F. McLoughlin, Pelham, NH (US); J. Karl Niermeyer, Tyngsboro, MA (US); Joseph E. Smith, N. Andover, MA (US); Rosario Mollica, Wilmington, MA (US)

Correspondence Address: SPRINKLE IP LAW GROUP, 1301 W. 25TH STREET, SUITE 408, AUSTIN, TX, 78705, US

(73) Assignee: Entegris, Inc., Chaska, MN (US)

(21) Appl. No.: 12/024,689

(22) Filed: Feb. 1, 2008

Related U.S. Application Data
(60) Provisional application No. 60/899,299, filed on Feb. 2, 2007.
(60) Provisional application No. 60/925,220, filed on Apr. 19, 2007.

(51) Int. Cl. B67D 5/56; G05D 11/13; B01F 15/04

(52) U.S. Cl. 137/3; 222/145.6; 366/160.2; 366/182.4; 222/244

(57) ABSTRACT

Embodiments disclosed herein provide a pump or a multiple-pump system that can mix chemicals without dilution tanks and can dispense the mixture of chemicals in a precise and highly controllable manner, particularly useful in semiconductor manufacturing processes. In some embodiments, one or more piston pumps of similar displacement are used to mix and dispense the chemical directly. A first valve is opened to a first chemical source. A piston is moved in a first direction to a selected position in a chamber to draw the first chemical into the chamber. The first valve is closed and a second valve is opened to a second chemical source. The piston is moved in the first direction to a second position in the chamber to draw in the second chemical and mix the chemicals. The second valve is closed and the piston is moved to dispense the fluids through a dispense port.

### CROSS-REFERENCE TO RELATED APPLICATIONS

This application claims priority from Provisional Patent Applications No. 60/899,299, filed Feb. 2, 2007, entitled “CHEMICAL DILUTION AND DISPENSE PUMP” and No. 60/925,220, filed Apr. 19, 2007, entitled “CHEMICAL DILUTION AND DISPENSE PUMP,” the entire contents of which are expressly incorporated herein by reference for all purposes.

### TECHNICAL FIELD

This disclosure relates generally to chemical supply systems used in the semiconductor manufacturing industry and more particularly to a system and method for mixing and dispensing chemicals in a precise and highly controllable manner without using dilution tanks.

### BACKGROUND OF THE RELATED ART

Prior art chemical supply systems used in the semiconductor manufacturing industry include tanks to mix or dilute chemicals. As FIG. 1 exemplifies, in a prior art chemical supply system, chemicals are mixed in tank 130 by filling tank 130 with a quantity of a chemical from first source or container 100 into tank 130 up to a level as indicated by sensor 420 and then filling tank 130 with an additional quantity of a second chemical from second source or container 110 up to a level as indicated by sensor 430, Level sensors 410, 420 and 430 are used to determine when the correct quantity of each fluid is achieved in order to control the relative concentration of chemicals. Tank 130 is typically pressurized with an inert gas such as nitrogen from supply 120 via check valve 331.

One problem common to prior art chemical supply systems such as one shown in FIG. 1 is that sensors 410, 420 and 430 must be physically placed at particularly selected positions on tank 130. Thus, when the chemical concentrations change, sensors 410, 420 and 430 often need to be re-positioned accordingly. Other prior art approaches use gravimetric weight based sensors such as load cells to determine when the correct amount of chemical is obtained.

Typically, the tank filling process is controlled by sequentially opening and closing valves 310 and 320. Check valves 311 and 321 may be used to prevent contamination of chemical sources 100 and 110. In some cases, the mixture is re-circulated and/or “bubbled” with an inert gas to maintain a uniform concentration.

Once the chemicals are mixed in tank 130, a syringe or rolling edge diaphragm pump 140 draws in the mixed chemicals from tank 130 via valve 340. Pumps used in the semiconductor industry must be made of materials that do not add material extractables that can damage the yield of the process. The pumps dispense the mixed chemicals in a controlled fashion by pushing the fluid out to outlet 160 at a predetermined rate. The chemical streams of individual pumps can be mixed downstream of the pump outlets to create additional chemical mixtures. Chemical mixing downstream of the pumps allows for additional control over process parameters such as temperature. Tank 130 may be drained via drain 150 by opening valve 350.

Prior art chemical supply systems thus contains dilution tanks, volume level or gravimetric instrumentation, and associated recirculation pumps and plumbing, requiring more space with a larger footprint and corresponding material cost.

### SUMMARY OF THE DISCLOSURE

Embodiments of the disclosure include a pump or a multiple-pump system that can mix chemicals without dilution tanks and can dispense the mixture of chemicals in a precise and highly controllable manner, particularly useful in semiconductor manufacturing processes. In some embodiments, one or more piston pumps of similar displacement are used to mix and dispense the chemical directly. The uniformity of the mixture can be monitored with temperature sensor(s), pressure sensor(s), and any of the forms of concentration sensors that can be placed within the pump volume. A pump controller allows the possibility for closed loop control of the mixture key process parameters. Each controller channel also has the capabilities to measure other sensors such as temperature, dielectric constants and so on. These sensors could be used as a control or status signals to validate process integrity.

Embodiments described herein may have a lower volume of diluted chemicals (i.e., hold-up volume), which produces less chemical waste when the overall system is flushed. In some embodiments, smaller filters which can be placed inline with the pumps are utilized. As compared to larger filters which are utilized in prior art chemical supply systems and which are placed inline before and/or between mixing tanks, smaller filters may be easier to install, require less time to condition, and generally cost less than larger filters

Embodiments described herein may enable users to have higher control over reconfiguring their process chemistry mix ratios. The level sensors utilized in prior art chemical supply systems generally only produce discrete mix ratios. Thus, in prior art chemical supply systems, reconfiguring of the mix ratios requires moving the position of the level sensors. In embodiments disclosed herein, a user can change the parameters downloaded electronically to the pump controller to change the mixture proportions, making reconfiguring of the mix ratios much easier and faster.

Embodiments disclosed herein provide a variety of advantages. One advantage is the lower space requirement and hence smaller footprint due to the fact that dilution tanks are not required. The elimination of dilution tanks also provides the advantage of lower cost as corresponding instrumentation (e.g., multiple level sensors) and plumbing for such dilution tanks are also eliminated. Moreover, because fewer components such as level sensors are used, embodiments described herein may have a lower maintenance cost due to shorter assembly times and improved reliability.

These, and other, aspects and advantages of the disclosure will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 depicts a diagram of a prior art system for mixing chemicals used in semiconductor processing;

FIG. 2 depicts a schematic diagram of one embodiment of a system for mixing chemicals for a semiconductor manufacturing process;

FIGS. 3A and 3B depict views of one embodiment of a pump having a diaphragm in alternate positions;

FIG. 4 depicts a graph of the concentration (% by weight) variability for titration results according to one embodiment;

FIG. 5 depicts a simplified side view of one embodiment of a system for mixing chemicals for a semiconductor manufacturing process; and

FIG. 6 depicts a simplified side view of one embodiment of a system for mixing chemicals for a semiconductor manufacturing process.

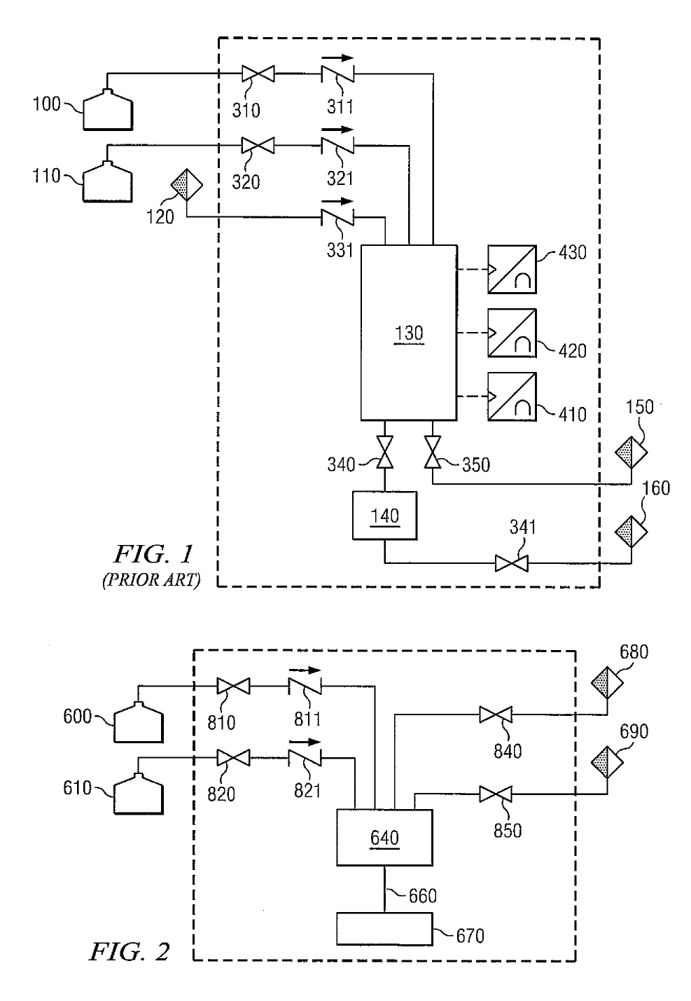

### DETAILED DESCRIPTION

The invention and the various features and advantageous details thereof are explained more fully with reference to the non-limiting embodiments that are illustrated in the accompanying drawings and detailed in the following description. Descriptions of well known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

Reference is now made in detail to the exemplary embodiments, examples of which are illustrated in the accompanying drawings. Wherever possible, the same reference numbers will be used throughout the drawings to refer to the same or like parts (elements).

Embodiments disclosed herein are particularly useful for drawing chemicals from multiple sources, mixing the chemicals to form a solution having a desired concentration, and dispensing the chemical mixture in a semiconductor manufacturing process.

FIG. 2 depicts a diagram schematically illustrating a pump system for mixing chemicals. The mixtures may be simple chemical dilutions involving de-ionized water or other chemical mixtures. More than two chemicals can also be mixed in embodiments disclosed herein.

In some embodiments, a method of tank-less chemical dilution and dispense may comprise the steps of, according to signals from controller 670, drawing a first chemical from first chemical source 600 into pump 640, drawing a second chemical from second chemical source 610 into pump 640, mixing the first and second chemicals in pump 640 to a predetermined ratio, and dispensing mixed chemicals via outlet 690. In some embodiments, pump 640 is an IntelliGen® Mini photolithography rolling edge diaphragm pump available from Entegris®, Inc. of Chaska, Minn., U.S.A. Entegris® and IntelliGen® are registered trademarks owned by Entegris, Inc. In some embodiments, pump 640 may be a pump with reduced form factor. Examples of a pump with reduced form factor can be found in U.S. patent application Ser. No. 11/602,464, filed Nov. 20, 2006, entitled “SYSTEM AND METHOD FOR A PUMP WITH REDUCED FORM FACTOR, which claims priority from Provisional Application No. 60/742,435, filed Dec. 5, 2005, both of which are incorporated herein by reference as if set forth in full.

More specifically, in some embodiments, a method of tank-less chemical dilution and dispense may comprise the steps of opening inlet valve 810 located between first chemical source 600 and pump 640. In some embodiments, pump 640 may draw a selected amount of the first chemical based on manual instruction, programmed instruction, a recipe or the like. In some cases, inlet valve 810 may be closed to prevent any additional amount of the first chemical from entering pump 640. In some embodiments, check valve 811 may be used to prevent drawback from pump 640 from entering and contaminating first source 600. Next, inlet valve 820 located between second chemical source 610 and pump 640 may be opened. In some embodiments, pump 640 may draw a selected amount of the second chemical based on manual instruction, programmed instruction, a recipe or the like. In some cases, inlet valve 820 may be closed to prevent any additional amount of second chemical from entering pump 640. In some embodiments, check valve 821 may prevent drawback from pump 640 from entering and contaminating second source 610.

In some embodiments, gas in pump 640 may need to be discharged. To discharge gas, vent valve 840 may be opened and pump 640 may force gas out through vent valve 840 to drain 680. Vent valve 840 may be closed to prevent chemicals from exiting pump 640.

In some embodiments, chemicals may be expelled from pump 640 by opening outlet valve 850 and forcing the chemical mixture through outlet valve 850 to outlet or dispense point 690. In some embodiments, pump 640 may operate to dispense the chemical mixture at a controlled rate (e.g., cc/sec), or may operate to dispense a specified amount of the chemical mixture to outlet or dispense point 690.

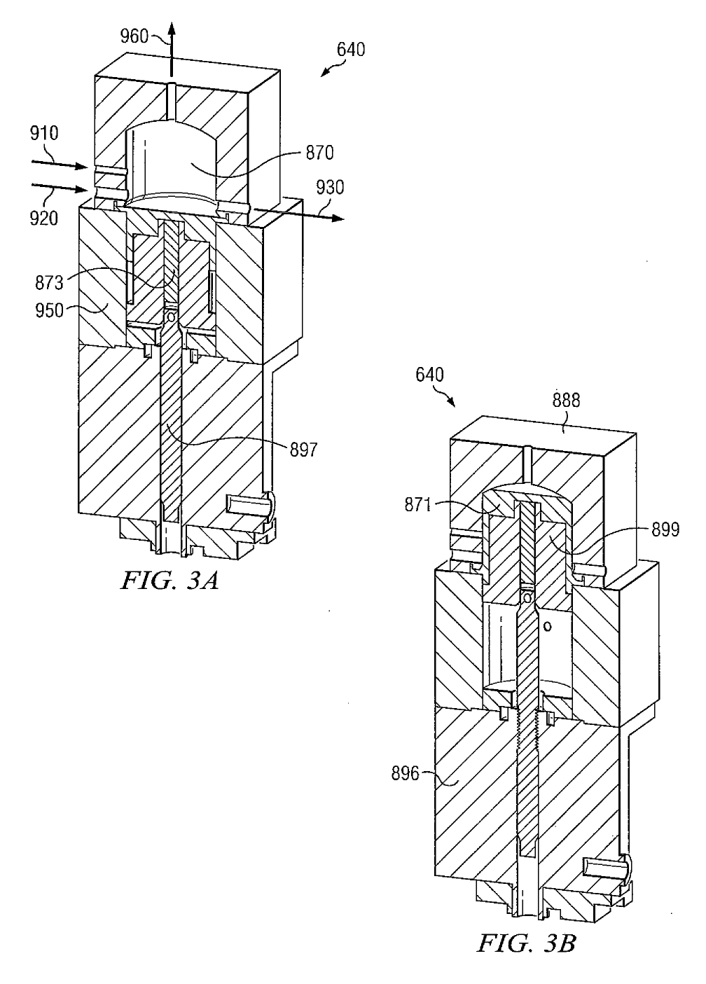

In some embodiments, controller 670 may be coupled to pump 640 via connection 660 for directing pump 640 to alternate chemical fill cycles, vent gases, and vary diaphragm fill stroke speed. In some embodiments, controller 670 may be a microprocessor-based controller. In some embodiments, controller 670 may include an ARM-based microprocessor. In some embodiments, microprocessor 670 may include 128 kilobytes (KB) flash memory, 128 KB static RAM memory, 32 KB electrically erasable programmable read-only memory (PROM), 8 24-bit analog input channels and run at 60 million instructions per second (MIPS). Controller 670 may include hardware to control external valves, and may accept firmware upgrades in the field. Controller 670 may also include a pump head pressure sensor (not shown), which is operable to send a signal corresponding to the pressure sensed in pump 640. Controller 670 may be operable to receive and analyze the signals received from a pump head pressure sensor, such as located inside chamber 870 (see FIG. 3A), to determine the pressure inside pump 640 and adjust the volume of the chamber inside pump 640, open vent valve 840, or open or shut valves 810, 820, and 850 to prevent overload conditions.

A user can interface with controller 670 in a number of different methods, including, but not limited to, serial, pendant, touch screen or analog inputs. Controller 670 may save input parameters and directions from the user to make a “recipe” for each channel. Recipes can be stored in memory of controller 670 for each channel of the system and recalled. A selected “recipe” may be created on demand. Each channel can operate independently for two different chambers (discussed below) in pump 640, or the operation of two channels may be interlocked, which would prevent dispense of both chemical channels together, for a single chamber application. In some embodiments, controller 670 is operable to receive a recipe for a desired chemical output and the chemicals stored in chemical sources 600 and 610, and controller 670 calculates the movement type (dispense, mix, fill), direction and speed of each motor.

FIGS. 3A and 3B depict views of one embodiment of a pump operable to perform tank-less chemical dilution and dispense. In FIGS. 3A and 3B, pump 640 may have motor 896 connected via motor lead screw 897 and rod 873 to piston 899 having rolling edge diaphragm 871. In some embodiments, motor 896 may be operable to rotate motor lead screw 897 a selected number of rotations to move piston 899 and rolling edge diaphragm 871 downwards into diaphragm housing 950 in order to fill pump chamber 870.

In some embodiments, motor 896 is a brushless DC motor (BLDCM) from EAD Motors of Dover, N.H., U.S.A. In operation, the stator of motor 896 generates a stator flux and the rotor generates a rotor flux. The interaction between the stator flux and the rotor flux defines the torque and hence the speed of motor 896. In one embodiment, a digital signal processor (DSP) may be used to implement all of the field-oriented control (FOC). The FOC algorithms may be realized in computer-executable software instructions embodied in a computer-readable medium. Digital signal processors, along with on-chip hardware peripherals, are available with the computational power, speed and programmability to control motor 896 and execute the FOC algorithms in microseconds with relatively insignificant add-on costs. Motor 896 may incorporate a position sensor to sense the actual rotor position. The position sensor (not shown) may be internal or external to motor 896. Using a position sensor may provide real-time feedback of the actual rotor position of motor 896, which may provide extremely accurate and repeatable control of the position of a mechanical piston, resulting in accurate and repeatable control over fluid movements and dispense amounts in a piston displacement dispense pump. Examples of a system and method for position control of a mechanical piston in a pump are described in U.S. patent application Ser. No. 11/602,485, filed Nov. 20, 2006, entitled “SYSTEM AND METHOD FOR POSITION CONTROL OF A MECHANICAL PISTON IN A PUMP,” which claims priority from Provisional Applications No. 60/741,660, filed Dec. 2, 2005, and No. 60/841,725, filed Sep. 1, 2006, all of which are incorporated herein by reference as if set forth in full.

Motor 896 operable to move piston 899 and rolling edge diaphragm 871 can be any suitable motor including a stepper motor or a brushless DC motor. In some embodiments, motor 896 is a brushless DC motor that offers 0.000109 cc/lines of resolution. The ability to accurately control the position and movement of piston 899 and rolling edge diaphragm 871 can result in very accurate amounts of chemicals drawn in and expelled from chamber 870. Motor 896 may be operable to move piston 899 and rolling edge diaphragm 871 a select number of lines. In some embodiments, the accuracy specification for pump 640 can be +/−0.02 cc. A stepper motor may also be used that would result 0.0012 cc/step of resolution at a cost benefit. Such a high resolution can be particularly useful in semiconductor manufacturing applications. For perspective, a drop of water from a ¼″ line is about 0.035-cc.

In some embodiments, chemical inlet ports 910 and 920 and discharge port 930 may be located at the sides of pump body 888. In some embodiments, inlet ports 910 and 920 may be oriented tangential to chamber 870 to improve mixing performance. In some embodiments, inlet ports 910 and 920 may vary in size or nozzle shape, depending upon the mix ratios and/or other parameters. In some embodiments, valves, including control valves and/or check valves, may be located at each port 910, 920 and 930. In some embodiments, inlet ports 910 and 920 may include multiple ports. The design, positioning, and orientation of ports 910, 920 and 930 may minimize hold-up volume preventing unmixed chemical locations. For examples of a system and method for a variable home position dispense system which can be utilized for minimizing hold-up volume for a dispense pump, readers are directed to U.S. patent application Ser. No. 11/666,124, filed Apr. 24, 2007, entitled “SYSTEM AND METHOD FOR A VARIABLE HOME POSITION DISPENSE SYSTEM,” which claims priority from International Application No. PCT/US2005/042127, filed Nov. 21, 2005, which claims priority from Provisional Application No. 60/630,384, filed Nov. 23, 2004, all of which are incorporated herein by reference as if set forth in full. For examples of a system and method for a valve plate which can be utilized for minimizing hold-up volume, readers are directed to U.S. patent application Ser. No. 11/602,457, filed Nov. 20, 2006, entitled “FIXED VOLUME VALVE SYSTEM,” which claims priority from Provisional Application No. 60/742,147, filed Dec. 2, 2005, entitled “VALVE PLATE SYSTEM AND METHOD,” all of which are incorporated herein by reference as if set forth in full.

Mixing hot and cold inlets of the same chemical may also be performed to achieve a desired temperature for the dispensed fluid. A temperature sensor (not shown) may be positioned in chamber 870 to determine whether hot or cold chemicals are to be drawn into pump 640 to reach a desired setpoint temperature. Rolling edge diaphragm 871 may separate potentially damaging chemicals from diaphragm housing 950 components and motor lead screw 897. In FIG. 3A, rolling edge diaphragm 871 is depicted in a position in pump body 888 to form chamber 870, which allows chemicals from first and second sources 910 and 920 to be drawn into pump 640.

FIG. 3B shows rolling edge diaphragm 871 in an alternate position to decrease the volume of chemicals allowed in chamber 870. Motor 896 may be operable to rotate motor lead screw 897 a selected number of rotations to move rolling edge diaphragm 871 upwards into pump body 888 in order to discharge chemicals from pump chamber 870. Opening discharge port 930 allows chemicals mixed in chamber 870 to be expelled from chamber 870 and transmitted to a dispensing point or outlet. In some embodiments, controller 670 may enable a user to select the operation of motor 896 such that direction of travel, rate of travel, distance of travel, and the position of rolling edge diaphragm 871 may be selected. In some embodiments, controller 670 may enable a user to directly control operation of motor 896 for manual operations. In some embodiments, controller 670 may also enable a user to program operation of motor 896 for automated operation.

In some embodiments, dispense of bubbles are to be avoided when the dispensed chemical will be applied directly onto a wafer. In some embodiments, vent port 960 may be located on top of chamber 870 where gas phase chemicals would normally collect. In some embodiments, a vent sequence can be utilized to displace gases that may result in bubbles. Examples of a system and method for valve sequencing in a pump that can be utilized are described in U.S. patent application Ser. No. 11/602,465, filed Nov. 20, 2006, entitled, “SYSTEM AND METHOD FOR VALVE SEQUENCING IN A PUMP,” which claims priority from Provisional Application No. 60/742,168, filed Dec. 2, 2005, both of which are incorporated herein by reference as if set forth in full.

By opening vent port 960 and moving piston 899 and rolling edge diaphragm 871 upward, gases formed during the mixing process may be vented through vent port 960, leaving only desired chemicals in chamber 870. The ability to decrease bubbles in the chemicals can be highly desirable in semiconductor manufacturing processes.

In some embodiments, an exit port such as port 960 or 930 may be used for sampling chemical concentrations for testing and improving chemical concentrations. A data acquisition procedure according to one embodiment may include collecting a dispensed product, drawing samples from the collected product, analyzing the samples, and comparing the samples to calibrate or known samples from prepared mixtures. Embodiments disclosed herein are operable to move piston 899 and rolled edge diaphragm 870 a selected distance such that a precise amount of the mixed chemical concentration may be collected and analyzed. As a specific example, a data acquisition procedure according to one embodiment may include collecting 10 cc dispense product in four test tubes for approximately 2.5 cc per tube, drawing 10 μL samples from the tubes, analyzing the samples using Mettler Toledo (DL58) Titrator, and comparing the dispense samples to known samples from prepared mixtures, which may comprise approximately 15 and 20% sulfuric acid.

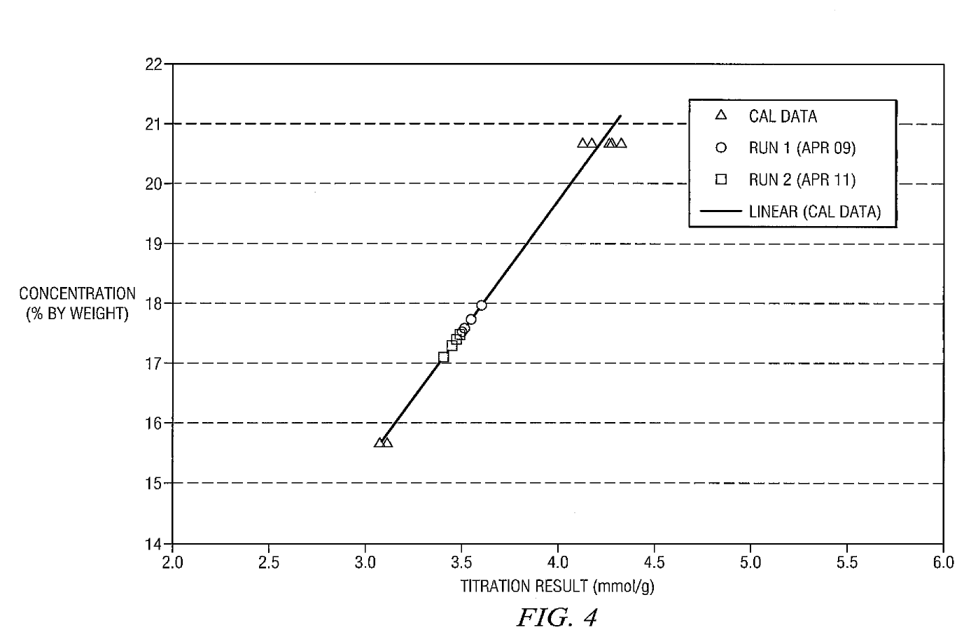

Low variation in chemical uniformity generally results in better process yields in the semiconductor manufacturing applications. In addition to eliminating the need for dilution tanks, embodiments disclosed herein can improve mixture uniformity through innovative port placement and inlet nozzle configuration. FIG. 4 depicts a plot showing titration results produced by one test configuration. The titration results demonstrate that it is possible for embodiments disclosed herein to achieve desirable uniformity without dilution tanks. In the example of FIG. 4, for titration around 3.5 mmol/g, the concentration is between about 17-18% by weight, resulting a concentration spread of less than 1% (i.e., the variability of the concentration is <1%).

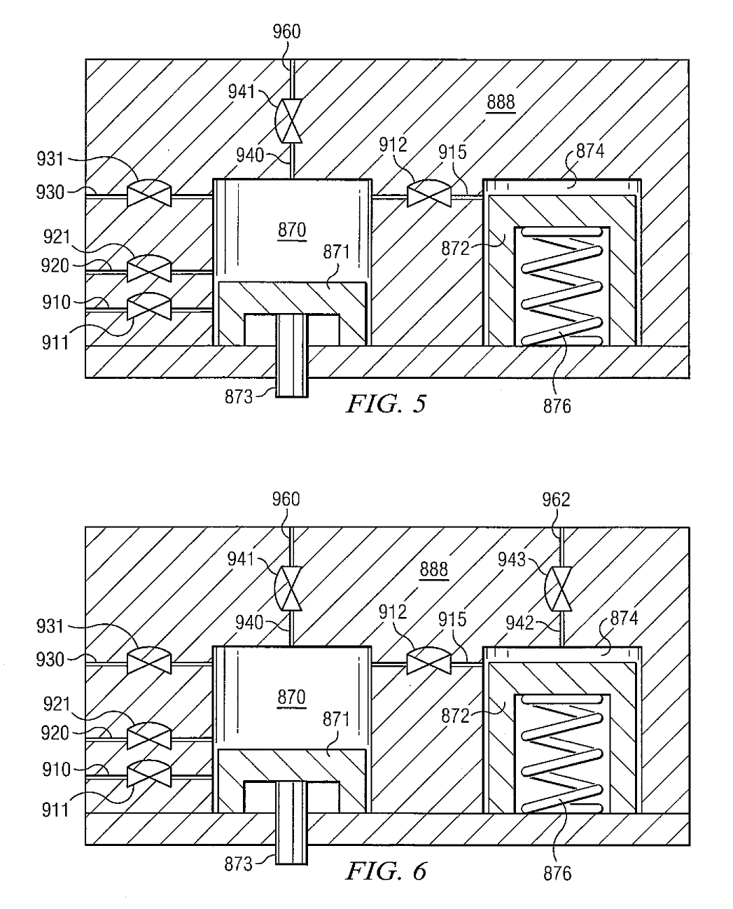

Those skilled in the art will appreciate that embodiments disclosed herein may be implemented in various ways without departing from the spirit and scope of the invention. FIGS. 5 and 6 depict simplified schematic diagrams illustrating exemplary dual-chamber configurations which may be useful for two-stage mixing of chemicals or other processing. In FIG. 5, two chemicals may be drawn into first pump chamber 870 through chemical inlet ports 910 and 920 as described above. In some embodiments, outlet 930 may be a dispense point and port 940 a vent port. In some embodiments, outlet 960 may be a dispense point, port 940 a dispense port, and port 930 a vent port. Other arrangements of inlet, outlet, and vent ports are also possible and anticipated. In some embodiments, each of such port may have one or more corresponding control valve. In some embodiments, each of such port may have at least one corresponding check valve.

In the example of FIG. 5, before sending the fluid out for dispense, the fluid may be expelled to second pump chamber 874 through cross over port 915 or multiple cross over ports. In some embodiments, this can be done by closing valves 911, 921, 931, and 941, opening cross over port valve 912, and moving piston 899 (see FIGS. 3A and 3B) and rolling edge diaphragm 871 upward to displace the fluid in chamber 870. In some embodiments, piston 899 and rolling edge diaphragm 871 of pump chamber 870 may be driven by rod 873 connected to motor lead screw 897 as described above with reference to FIGS. 3A and 3B. In some embodiments, second chamber 874 may be defined by rolling edge diaphragm 871 that is driven by a rod. In some embodiments, rolling edge diaphragm 871 of second chamber 874 may be actuated pneumatically, by pressure, by spring 876 as shown in FIG. 5, or by other suitable mechanism(s).

As the chemical mixture in first chamber 870 is displaced by rolling edge diaphragm 871, it crosses over to second chamber 874, further mixing its constituents in the process. The uniformity of the mixture may be enhanced due to the fluid agitation caused by the flow between chambers 870 and 874. In some embodiments, the mixture can be drawn or otherwise returned to first chamber 870 through cross over port 915 and valve 912 by moving actuator rod 873 and hence rolling edge diaphragm 871 down. In some embodiments, any gas that has accumulated may be disposed of by driving rolling edge diaphragm 871 upward and push the gas out through vent port 940, past vent valve 941 through outlet 960. Valve 941 may be closed to prevent unwanted escape of chemicals from chamber 870. In some embodiments, to dispense the chemical mixture from chamber 870, valve 931 may be opened and rolling edge diaphragm 871 may be moved to push the chemical mixture toward dispense port 930 for dispensing to a semiconductor manufacturing system through port 930. All other valves may be closed at this point.

In FIG. 6, second chamber 874 may have port 942 connected via valve 943 to outlet 962, which may allow sampling from second chamber 874, venting gases from second chamber 874, dispensing from second chamber 874, adding chemicals to second chamber, or the like. In some embodiments, second chamber 874 may be smaller than first chamber 870 to form small quantities of a chemical using the third chemical as a basis. For example, first chamber 870 may be used to mix two chemicals to form a third chemical that may have multiple uses, and second chamber 874 may be used to draw a portion of the third chemical and add a fourth chemical to form a fifth chemical having limited uses. Advantageously, the chemicals may be mixed only as needed, without the tanks and corresponding instrumentation and tubing required by prior art chemical supply systems. In some embodiments, mixed chemicals may be dispensed directly from second chamber 874 via dispense valve 943. In some embodiments, dispense port 962 may be connected to a process drain and used during a sequence to rinse chemicals from second chamber 874. Second chamber dispense port 962 may be connected to a tubing such that a chemical mixture is dispensed for processing. In some embodiments, the flow rate for a chemical dispensed from second chamber 874 may be actively controlled by controller 670 and motor 896, or may be controlled by a mechanism such as spring 876.

In the foregoing specification, the disclosure and inventive concepts have been described with reference to specific embodiments. However, one of ordinary skill in the art will appreciate that various modifications and changes can be made without departing from the spirit and scope of the disclosure provided herein. Accordingly, the specification and figures disclosed herein are to be regarded in an illustrative rather than a restrictive sense, and all such modifications are intended to be included within the scope of the disclosure which is defined by the following claims and their legal equivalents.

What is claimed is:

1. A method for mixing chemicals useful in a semiconductor manufacturing process, comprising:
drawing a first chemical from a first source into a chamber in a pump;
drawing a second chemical from a second source into the chamber; and
moving a rolling edge diaphragm of the pump to mix the second chemical and the first chemical in the chamber of the pump.

2. The method of claim 1, further comprising moving a piston that drives the rolling edge diaphragm of the pump to a selected position for drawing a selected amount of the first chemical or the second chemical into the chamber.

3. The method of claim 1, further comprising:
opening a first valve to the first source;
moving a piston that drives the rolling edge diaphragm of the pump to a first selected position for drawing a selected amount of the first chemical into the chamber;
closing the first valve to the first source;
opening a second valve to the second source;
moving the piston from the first selected position to a second selected position for drawing a selected amount of the second chemical into the chamber;
closing the second valve to the second source;
opening a third valve; and
moving the piston to dispense the first and second chemicals from the chamber through the third valve.

4. The method of claim 1, wherein the pump is coupled to a controller and wherein the rolling edge diaphragm is moved according to signals from the controller for drawing a predetermined ratio of the first and second chemicals.

5. The method of claim 1, further comprising:
opening a vent valve;
moving the rolling edge diaphragm to expel gas through the vent valve; and
closing the vent valve.

6. The method of claim 1, further comprising moving the rolling edge diaphragm at a selected speed.

7. The method of claim 1, further comprising moving the first and second chemicals from the chamber of the pump to a second chamber of a second pump via a cross over port.

8. The method of claim 7, further comprising agitating the first and second chemicals using the chamber of the pump and the second chamber of the second pump.

9. An apparatus for mixing chemicals comprising:
a pump comprising:
a chamber comprising:
a first port for connection to a first set of tubing;
a second port for connection to a second set of tubing; and
a piston operable to move in a first direction to draw chemicals into the chamber from the first and second sets of tubing and to expel chemicals from the chamber;
a rolling edge diaphragm defining the chamber in the pump; and
a motor operable to move the rolling edge diaphragm; and
a controller connected to the motor for controlling the operation of the motor.

10. The apparatus of claim 9, wherein the controller is operable to drive a piston of the motor for selectively positioning the rolling edge diaphragm.

11. The apparatus of claim 9, wherein the motor comprises a brushless DC motor.

12. The apparatus of claim 9, wherein the motor comprises a stepper motor.

13. The apparatus of claim 9, further comprises a second pump having a second chamber defined by a second rolling edge diaphragm, wherein the chemicals are expelled from the chamber of the pump to the second chamber of the second pump.

14. The apparatus of claim 13, wherein the chemicals are dispensed from the second pump.

15. A system comprising:
a pump comprising:
a first chamber comprising:
a first inlet port for connection to a first set of tubing;
a second inlet port for connection to a second set of tubing; and
a first piston operable to move in a first direction to draw chemicals into the first chamber from the first and second sets of tubing and to expel chemicals from the first chamber; and
an exit port;
a motor operable to move the first piston from a first position to a second position;
a controller connected to the motor for controlling the operation of the motor;
a first set of tubing connecting said first inlet port to the first chemical source, the set comprising:
a first inlet valve; and
a first check valve; and
a second set of tubing connecting said second inlet port to the second chemical source, the set comprising:
a second inlet valve; and
a second check valve.

16. The system of claim 15, further comprising:
a second chamber connected to the first chamber;
a valve positioned between the first chamber and the second chamber and operable to control fluid flow between the first and second chambers; and
a second piston operable to move in a first direction and a second direction in the chamber, wherein moving the second piston in the first direction allows fluid to flow from the first chamber to the second chamber and moving the second piston in the second direction forces the fluid from the second chamber to the first chamber.

17. The system of claim 16, wherein the second piston comprises a rolling edge diaphragm.

18. The system of claim 16, wherein the second chamber comprises a mechanism for controlling the flow of fluid between the first and second chambers.

19. The system of claim 18, wherein the mechanism comprises a spring.

20. The system of claim 16, wherein the mechanism comprises a pump comprising:
a motor for moving the second piston in the first or second direction, wherein the controller is operable to control the first and second pistons to control fluid flow between the first and second chambers.
